(19) United States
(12) Patent Application Publication
(10) Pub. No.: US 2013/0139229 A1
(43) Pub. Date: May 30, 2013

(54) SYSTEM FOR SHARING PERSONAL AND QUALIFYING DATA WITH A THIRD PARTY

(71) Applicants: Lawrence Fried, San Francisco, CA (US); David Scott Shefferman, San Francisco, CA (US)

(72) Inventors: Lawrence Fried, San Francisco, CA (US); David Scott Shefferman, San Francisco, CA (US)

(21) Appl. No.: 13/675,237

(22) Filed: Nov. 13, 2012

Related U.S. Application Data
(60) Provisional application No. 61/557,913, filed on Nov. 10, 2011.

(51) Int. Cl. H04L 29/06

(52) U.S. Cl. CPC H04L 63/08
USPC 726/5

(57) ABSTRACT

A method for users to share personal and qualifying information with a plurality of third parties. Authenticated users may share personal and qualifying information obtained from a plurality of data repositories comprising of credit data, motor vehicle data, insurance data, criminal data, sex offender data, occupancy data and employment data. The personal and qualifying information may be viewed by a plurality of third parties until the user revokes access at any time. Neither user nor third parties are allowed to alter data. However, users have the option to supply supplemental explanations for data. The method facilitates the development of trust necessary for transactions between two parties comprising of securing housing, obtaining loans, securing employment, etc.

### REFERENCE TO RELATED APPLICATIONS

This application claims the benefit of U.S. Provisional Patent Application No. 61/557,913 entitled A SYSTEM FOR SHARING PERSONAL AND QUALIFYING INFORMATION WITH A THIRD PARTY filed Nov. 10, 2011 which is incorporated herein by reference.

### BACKGROUND OF THE INVENTION

In many transactions between two parties who may or may not have transacted together previously, a level of trust between the parties is necessary. Oftentimes, this level of trust is reached when one party to the transaction does a background check or reviews personal data appropriate for the type of transaction to take place.
A mortgage bank requires a lengthy application, runs a credit check, confirms income and reviews banking balances as appropriate to determine the creditworthiness of an individual before approving a mortgage.
A lender requires an application for a car loan and runs a credit check as appropriate to determine the creditworthiness of the individual before approving a loan.
An employer requires a job application, checks personal and employment references, and depending on what's appropriate for the job being considered, may do any or all of the following before extending an offer of employment:
   order a credit report
   conduct a criminal background check
   drug testing
   fingerprint/bond the candidate
A landlord or property manager requires a rental application, checks personal and prior rental references and may order a credit report or criminal background check on a potential tenant before deciding whether to rent to the prospective tenant.

Typically, it is a lengthy and laborious process for one of the parties to collect and research information on the other party. Often, the process involves ‘shopping’, whether it be for an apartment, or the best pricing on a mortgage, and the same application and credit data is requested each time the consumer indicates interest, incurring repetitive time and expense to compile and provide similar data multiple times over.

In many cases, explicit permission is required from the party being researched, before the researching party can access information on them. For example, in any situation requiring the accessing of a credit report, the explicit permission and signature of the party being researched is required before a credit reporting agency can release that information to a third party.

From both a security and cost perspective, this process is inefficient. It often leaves an unsecure paper trail of names, account numbers, and personal and confidential information with the requesting party, regardless of whether the transaction is completed. This elevates the likelihood and opportunity for misuse, fraud, or even identity theft.

For example, a consumer may apply for a car loan at 3 banks, and only accept the terms and loan from one of the three. This leaves a trail of the consumer's personal loan application and credit information at all 3 institutions, even though only one will complete a transaction with the consumer. All 3 applications required a consumer to complete a lengthy loan application and incurred the expense of the same background and credit checks on the consumer.

As a result, there is a need for improvement in handling and sharing of personal and qualifying information with a third party.

1. Field of the Invention

The invention pertains to the field of data transmission methods. More particularly, the invention pertains to the field of enabling data exchange between parties using a third party intermediary.

2. Description of Related Art

### SUMMARY OF THE INVENTION

The invention presents a method for users to share personal and qualifying information with a plurality of third parties. Authenticated users may share personal and qualifying information obtained from a plurality of data repositories comprising of credit data, motor vehicle data, insurance data, criminal data, sex offender data, occupancy data and employment data. The personal and qualifying information may be viewed by a plurality of third parties until the user revokes access at any time. Neither user nor third parties are allowed to alter data. However, users have the option to supply supplemental explanations for data. The method facilitates the development of trust necessary for transactions between two parties comprising of securing housing, obtaining loans, securing employment, etc.

### BRIEF DESCRIPTION OF THE DRAWINGS

Various embodiments of the invention are disclosed in the following detailed description and the accompanying drawings.

FIG. 1 is a block diagram illustrating an embodiment of a system for sharing personal and qualifying information with a third party.

FIG. 2 is a block diagram illustrating an embodiment of a system for sharing consumer credit data with a third party.

FIG. 3 is a flow chart diagram illustrating an embodiment of a process for sharing personal and qualifying information with a third party when directed to do so by the user.

FIG. 4 is a flow chart diagram illustrating an embodiment of a process for a user to procure personal and qualifying information.

4

FIG. 5 is a flow chart diagram illustrating an embodiment of a process for a user to submit user generated content to be included with personal and qualifying information.

FIG. 6 is a flow chart diagram illustrating an embodiment of a process for a user to direct the sharing of personal and qualifying information with a third party.

FIG. 7 is a flow chart diagram illustrating an embodiment of a process for a third party to authenticate and view shared data hosted by the website or a data provider web server.

FIG. 8a is a diagram illustrating a specific example of a user selecting the set of personal and qualifying information to procure.

FIG. 8b is a diagram illustrating a specific example of a user being prompted to provide supplemental personal and qualifying information in the form of user generated content.

FIG. 8c is a diagram illustrating a specific example of a user reviewing the personal and qualifying data they have procured from third parties, with the options of viewing said data or directing the website server to share said content with a third party.

FIG. 8d is a diagram illustrating a user being prompted to provide contact information and a personal note for a third party to be invited to view the user's personal and qualifying information.

FIG. 9 is a diagram illustrating a specific example of a third party notification that a user has enabled permission to share personal and qualifying information with them.

FIG. 10 is a diagram illustrating a specific example of a user enabling or disabling permissions to share personal and qualifying information with a third party.

FIG. 11 is a diagram illustrating a specific example of a third party's ability to view personal and qualifying information on multiple users within their own secure login.

### DETAILED DESCRIPTION

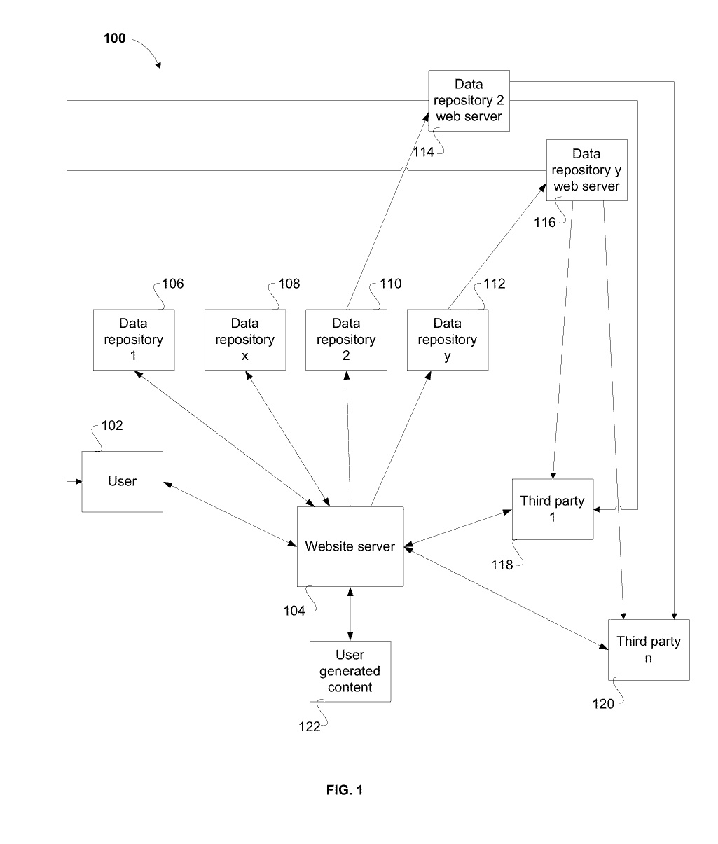

FIG. 1 is a block diagram illustrating an embodiment of a system for sharing of personal and qualifying information with a third party. In the example shown, system 100 is shown to include: user 102, website server 104, data repositories 106-112, data repository web servers 114-116 third parties 118-120, and user generated content 122.

User 102 is an individual or organization interested in sharing personal and qualifying information with third parties 118-120.

The personal and qualifying information is provided by data repository 106-112 and user generated content 122.

Each of the data repositories 106-112 is independent of each other and may be a separate repository with data about the user.

User generated content 122 provided by user 102 may be included when sharing the personal and qualifying information provided by data repository 106-112. Alternatively, user 102 may opt not to include user generated content 122 when sharing the personal any qualifying information provided by data repository 106-112.

In some embodiments, and in the examples herein, data for a particular user 102 comprises fields having field values. For example, the fields may include: name, creditor name, balance owed, payment history, account status, etc., and the values for those fields are stored by each data repository.

The personal and qualifying information from each data repository may include one or more fields in common. For example, data repository 108 may store the following data for a user: name, creditor name, balance owed and last payment date. Data repository 110 may store the following data for the same user: name, creditor name, and account status.

Website server 104 is configured in a variety of ways in various embodiments. In some embodiments, website server 104 may obtain data from one or more data repositories 106-108 and process that data for display. For example, data repository 106 may provide data about the user 102 to the website server 104 which gets processed for display.

Alternatively, website server 104 may deliver content which includes a secure frame receiving data from data repository 110-112 directly through data repository web server 114-116.

6

In some embodiments, data repositories 110-112 may display information directly through data repository web server 114-116 in a new browser window, without website server 104 having access to any of the data being displayed.

For example, data repository 110 may provide data directly through data repository web server 114, which gets securely framed into the web page delivered by website server 104 or data repository 110 may deliver data through data repository web server 114 about user 102 in a new browser window, without website server 104 having access to any of the data being displayed.

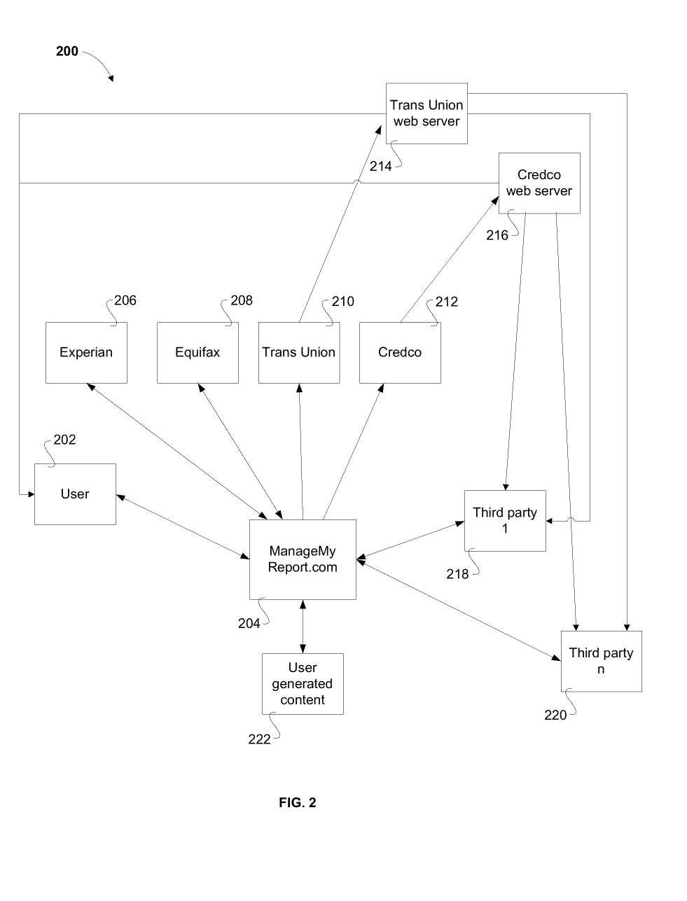

FIG. 2 is a block diagram illustrating an embodiment of a system for sharing consumer credit information with a third party. In the example shown, system 200 is shown to include: user 202, website server 204 (ManageMyReport.com), data repositories 206-212 (Experian, Equifax, Trans Union, Credco), data repository web servers 214-216 (Trans Union web server, Credco web server), third parties 218-220 and user generated content 222.

User 202 is an individual or organization interested in sharing personal and qualifying information with one or more third parties 218-220. User 202 may opt to procure data from data repositories 206-212 through ManageMyReport.com 204.

Each of data repositories 206-212 is independent of each other. For example, Experian, Trans Union and Equifax and Credco are separate organizations that store their own data and information about the user 102.

User 202 may also opt to create their own generated content 222 through ManageMyReport.com 204 with the option of also sharing this information with third parties 218-220. For example, user 202 may opt to procure data from Experian 206 and Trans Union 210 through ManageMyReport.com 204. The user may also opt to contribute user generated content 222 through ManageMyReport.com 204. The user may then opt to share only the data procured from Experian 206 and user generated content 222 with third party 218.

The data procured from Trans Union 210 will not be available to third party 218.

In this example, no data will be shared with third party 220 until user 202 explicitly identifies the data to share and instructs ManageMyReport.com 204 to allow data access to third party 220.

Although this and other examples herein describe repositories of consumer credit data, in various embodiments, the data repositories may be associated with any type of data, such as motor vehicle data, insurance data, criminal data, sex offender data, occupancy data and employment data, etc. In some embodiments, the data repository may provide information about a business or organization, such as analyst reports, corporate business filings, public tax returns, etc.

In some embodiments, the user may instruct website server 204 to share the same personal qualifying data to multiple third parties 218-220. For example, a user may share data from Experian 206 and a rental application 222 to more than one landlord 218-220 with the desire to be approved to rent one of multiple apartment units.

In some embodiments, the third party 218 may initiate the request for personal qualifying data to be shared by instructing user 202 to do so. This instruction may be made in person, in writing, by facsimile, by telephone, by email, or via the website server 204.

In operation, the user 202 has a credit report generated by credit reporting agencies. Experian 206, Equifax 208 and Trans Union 210. User 202 wants to rent an apartment, and knows that every prospective landlord will require that he complete a rental application, and most will require him to furnish a credit report, or otherwise agree to having them pull a report on his behalf.

To facilitate a smoother process when he identifies two or three apartments he may be interested in, user 102, goes to ManageMyReport.com 204 and purchases a credit report from Experian 206. He also completes an online rental application form on ManageMyReport.com 204 and stores it as user generated content 222.

As user 202 embarks on his apartment search, he identifies two apartments he would like to be considered for. He gets contact information from the respective landlords, in this case, in the form of their email addresses.

User 202 then returns to ManageMyReport.com 204 and directs ManageMyReport.com to share his user generated content (rental application) 222 and his Experian 206 credit report with third party (prospective landlords) 218 and 220.

A week later, when user 202 is approved to rent the apartment from landlord 220, to protect his identity and personal financial information, user 202 returns to ManageMyReport.com 204 and revokes access to his Experian 206 credit report and user generated content 222 rental application from third party 218 landlord, as there is no longer any utility in allowing third party 218 landlord to have access to the user's personal and qualifying information.

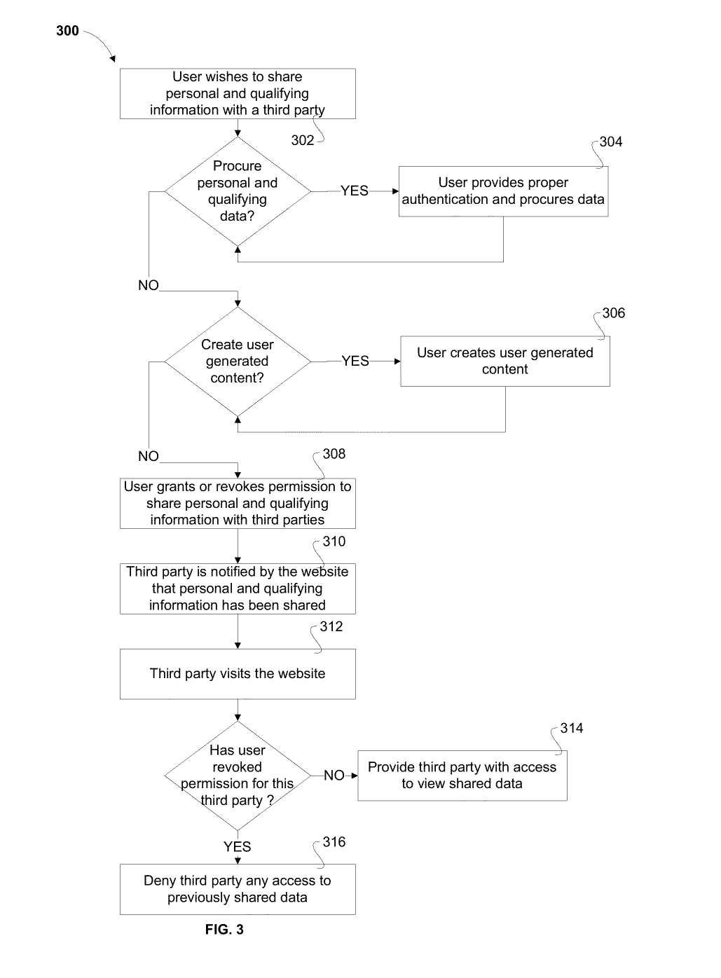

FIG. 3 is a flow chart diagram illustrating an embodiment of a process for sharing of personal and qualifying information with a third party. Examples of data that might be shared are consumer credit reports, motor vehicle data, insurance data, criminal data, sex offender data, occupancy data and employment data, etc.

At 302, a user wishes to share personal and qualifying information with a third party. Examples of data repositories with personal and qualifying information to share include but are not limited to: data repositories 206-212, and any repository of consumer credit data, motor vehicle data, insurance data, criminal data, sex offender data, occupancy data and employment data, etc. Examples of third parties who might receive this data include: landlords, financial advisors, lenders, sellers and creditors.

At 304, if the user chooses to procure information from a data repository, the user provides proper authentication and procures data from data repository 206-212.

At 306, if the user chooses, the user creates user generated content 222. Examples of user generated content include: rental applications, loan applications, and explanations of data or data elements within other personal and qualifying data being shared, etc.

At 308, the user grants or revokes permission for website server 204 to share selected personal and qualifying data with third party 218, and to notify said third party that personal and qualifying data is available to view. The user may share the personal and qualifying data procured from all data repositories with a third party. Alternatively, the user may select specific personal and qualifying data to provide to a third party and may also opt to include user generated content with some or all of the personal qualifying data being shared with a third party.

The user 202 may repeat 308 an unlimited number of times, sharing any combination of data from data repositories 206-212 and user generated content 222 with a plurality of third parties 218-220.

For example, a user may procure a driving history record from Experian 206 and a credit report from Equifax 208. The user may also create two pieces of user generated content 222, in the form of a rental application and an insurance application. The user would then direct ManageMyReport.com 204 to share the credit report from Equifax 208 and the rental application from 222 to two different third party landlords. And the user would direct ManageMyReport.com 204 to share the driving history record from Experian 206 and the insurance application from 222 to third party insurance broker.

At 310, the third party 218-220 receives notification that user 202 has shared personal and qualifying information with them. Examples of types of notifications include: email, telephone, facsimile, SMS message, MMS message, USPS letter, etc.

In the event the third party visits ManageMyReport.com 204, provides appropriate credentials and the ManageMyReport.com determines that sharing privileges have been revoked by the user 202, than at 316, the third party is denied access to view the personal and qualifying information. If the sharing privileges have not been revoked, then the personal and qualifying information designated to be shared with that specific third party is provided to them.

For example, a user may direct ManageMyReport.com 204 to share a credit report from Equifax 208 and a rental application from 222 to two different third party landlords 218 and 220. Upon being approved for the apartment offered by third party landlord 220, the user revokes the share permission to third party landlord 218. Any time after that, it third party landlord 218 visits ManageMyReport.com 204 to view the personal and qualifying data, it will no longer be available to them.

In operation, at 302, a user 202 has decided they wish to share personal and qualifying information with a third party potential landlord 218.

At 304, the user has decided to procure a credit report from Experian 206, and provides the proper authentication and payment to procure such data.

At 306, the user creates and stores user generated content 222 in the form of a rental application.

At 308, the user grants permission for third party landlord 220 to view the personal and qualifying information within the Experian 206 credit report and user generated content rental application 222.

At 310, the third party landlord 218 is notified by ManageMyReport.com 204 that personal and qualifying information about user 202 has been shared with them.

At 312, the third party landlord 218 visits ManageMyReport.com 204, and provides the appropriate credentials to view the personal and qualifying information that has been shared about user 202.

If third party landlord 218 still has permissions to view the shared personal and qualifying information, ManageMyReport.com 204 will display it. If user 202 has revoked permission for third party landlord 218 to view their personal and qualifying information, then ManageMyReport.com 204 will deny access to third party landlord 218

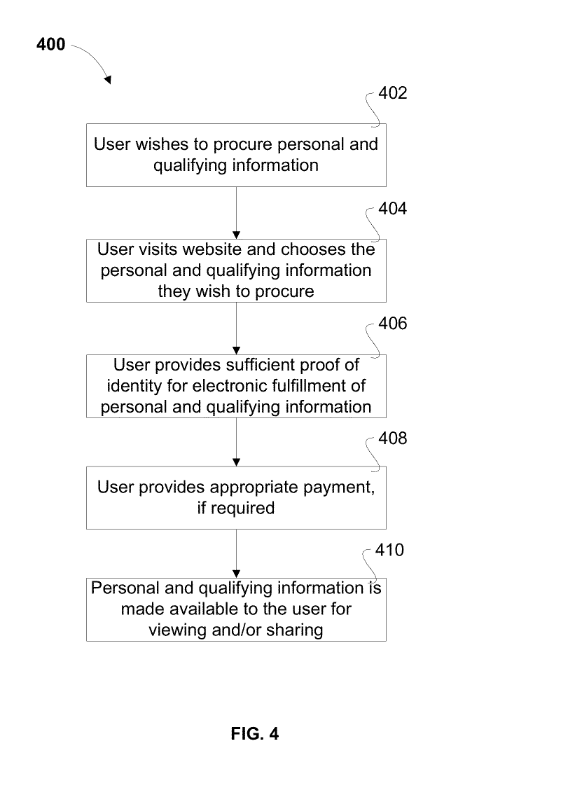

FIG. 4 is a flow chart illustrating the embodiment of a process for procuring personal and qualifying information from a data repository as in step 304 of FIG. 3. At 402 a user determines they wish to procure personal and qualifying data from a data repository. Examples of personal and qualifying information include: consumer credit reports, motor vehicle data, insurance data, criminal data, sex offender data, occupancy data and employment data, etc.

At 404 the user visits website server 204 and chooses the data repository 206-212 they wish to procure personal and qualifying information from.

Upon providing appropriate proof of identity 406 and payment 408, the desired personal and qualifying information is available to the user to view and share.

In operation, at 402, a user 202 wishes to procure a credit report from Experian 206 as in step 304 of FIG. 3.

At 404, the user 202 visits ManageMyReport.com 204 and chooses to purchase a credit report from Experian 206.

At 406, the user 202 satisfies Experian's requirements to prove his identity for electronic fulfillment of a credit report, and at 408 user provides payment for the credit report.

At 410, the Experian credit report 206 is available for viewing at ManageMyReport.com.

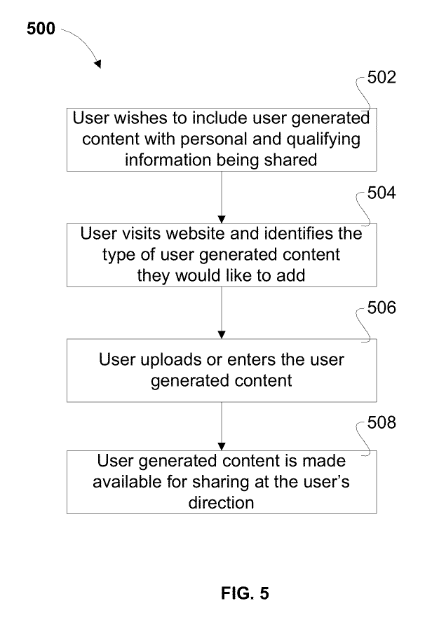

FIG. 5 is a flow chart illustrating the embodiment of a process for creating user generated content that can be included as personal and qualifying information to be shared as in step 306 of FIG. 3. At 502, the user determines they would like to include user generated content

At 504, the user visits the website server 202 and selects the type of user generated content they would like to add. Then at 506, the user uploads or enters the content they would like to include. At 508, the content is made available for sharing at the user's direction. Examples of user generated content include: rental applications, loan applications and explanations of data or data elements within other personal and qualifying data being shared, etc.

In operation, at 502, a user 202 wishes to provide user generated content 222 in the form of a rental application as in step 306 of FIG. 3.

At 504, the user 202 visits ManageMyReport.com and chooses to complete a rental application. At 506, the user 202 completes the user generated content 222 required to store a rental application. At 508, the rental application is made available to share at the user's direction.

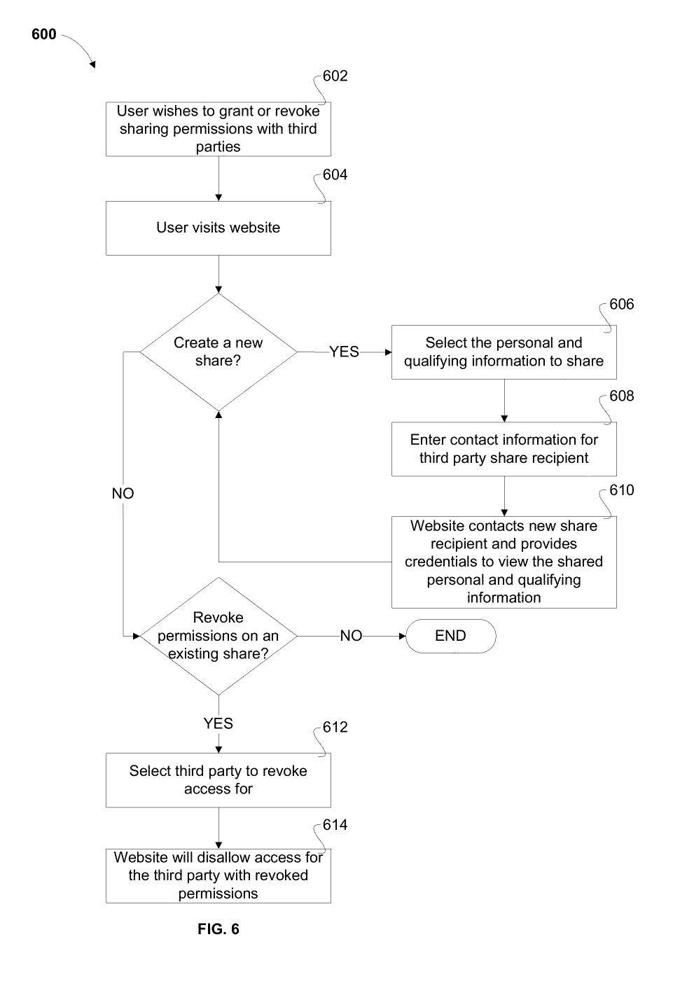

FIG. 6 is a flow chart illustrating the embodiment of a process for granting or revoking sharing permissions with third parties as in step 308 of FIG. 3. At 602, the user determines they would like to share personal and qualifying information with a third party.

At 604, the user visits website server 204 and, if granting new permissions, at 606 selects any combination of the personal and qualifying information 206-212 and user generated content 222 to share.

At 608, the user enters the contact information of the third party to share personal and qualifying information with. At 610, the website will then contact the third party to provide notification of the personal and qualifying information available to view. Examples of types of notifications include: email, telephone, facsimile, SMS message, MMS message, USPS letter, etc.

If the user 202 wishes to revoke sharing access from a third party 218-220, at 612 the user selects the third party to revoke access for and at 614, the website will disallow that third party's access to the user's personal and qualified data.

In operation, at 602, a user wishes to grant sharing permissions with a third party landlord 218. At 604, the user visits ManageMyReport.com and opts to create a new share and at 606, selects to share an Experian credit report 206.

At 608, the user enters the email address for the third party landlord 218 and at 610, ManageMyReport.com 204 emails the third party landlord 218 with credentials to access the personal and qualifying information.

If at any time, the user 202 should decide to revoke share permissions for the landlord 218, then at 612, the user may select the landlord 218 and revoke share permissions.

At 614, ManageMyReport.com 204 will disallow access for the landlord 218 to view the previously shared Experian credit report 206.

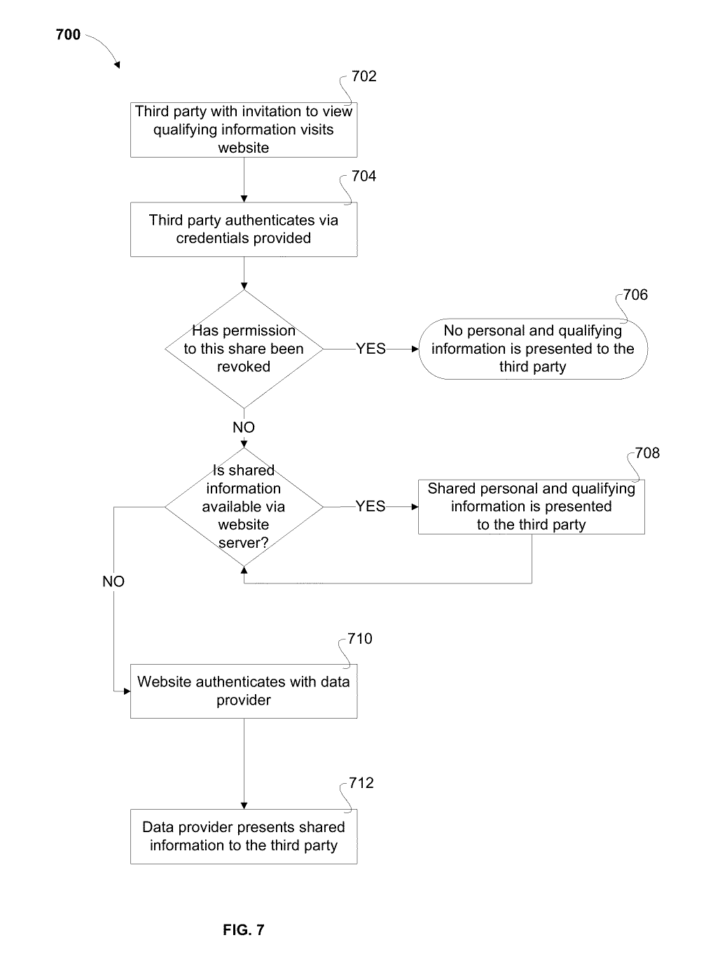

FIG. 7 is a flow chart illustrating the embodiment of a process for a third party to view qualifying information that has been shared with them as in step 314 of FIG. 3. At 702, the third party visits the website server and at 704, authenticates with the credentials provided to them.

At 706, if the user 202 has revoked permissions to share their personal and qualifying information, the third party 218-220 will not be presented with the personal and qualifying information that was previously shared with them.

At 708, if the personal and qualifying information is available to be presented by the website server 204, the data is presented to the third party 218-220.

If the personal and qualifying information is to be presented by the data repository web server 214-216, then at 710 the website server 204 authenticates with the appropriate data repository 206-212 and at 712 the data repository web server 214-216 will deliver the personal and qualifying information to the third party 218-220.

In operation, a landlord 218 receives an invitation to view a user's credit reports from Experian 206 and Trans Union 210 as well as a rental application 222. Upon visiting and logging into ManageMyReport.com 204, the landlord can choose which personal and qualifying information to view.

If the landlord chooses to view the Experian credit report 206, that data is delivered to the landlord via ManageMyReport.com 204 per 708.

If the landlord chooses to view the Trans Union credit report 210, then ManageMyReport.com 204 provides appropriate credentials to Trans Union 210 per 710 and receives a web link to display to the landlord. Upon clicking the provided link Trans Union web server 214 displays the appropriate data to the landlord per 712.

If the landlord chooses to view the rental application 222, then ManageMyReport.com 204 will deliver that data per 708.

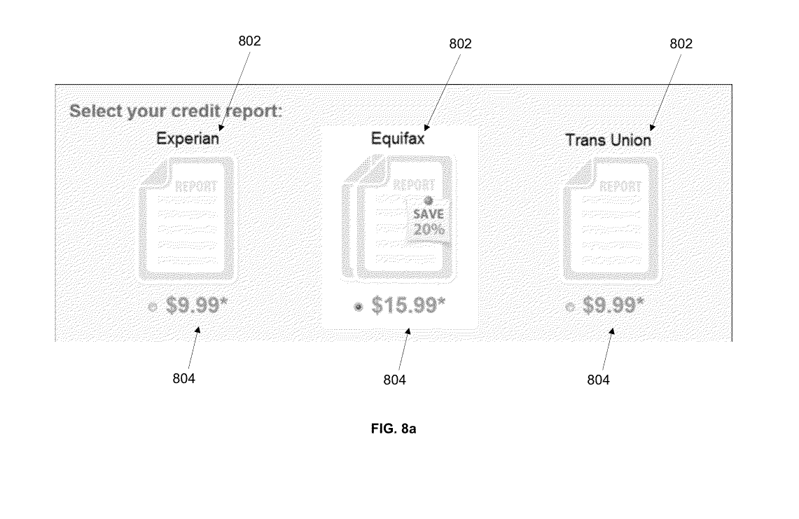

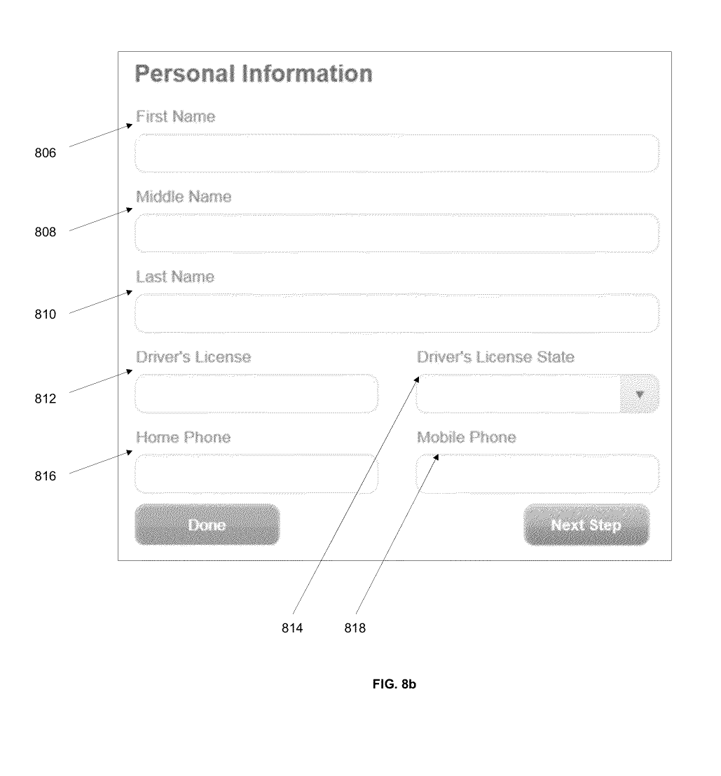

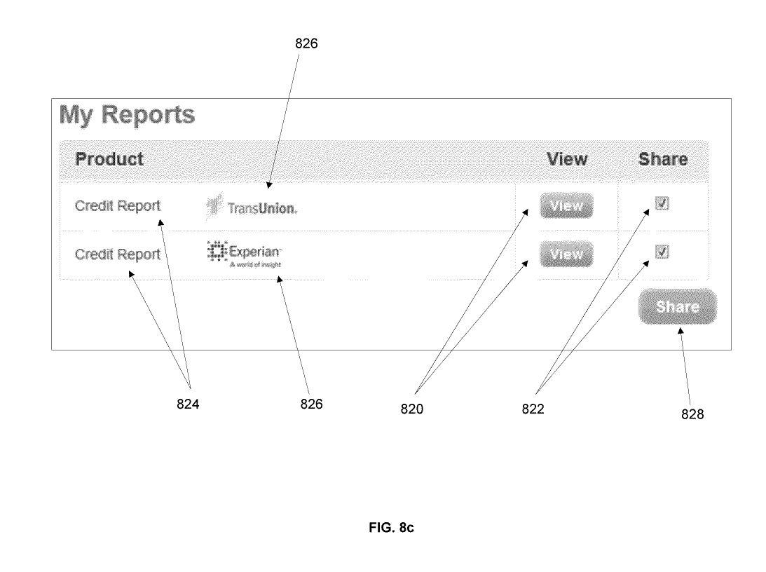

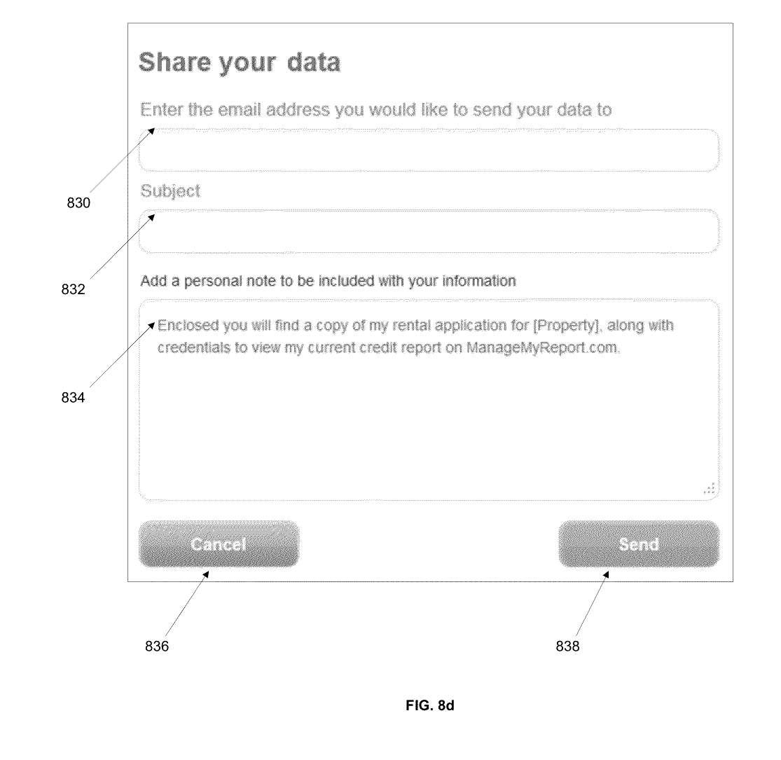

FIGS. 8a to 8d show illustrative screens which a user 202 might use to procure and share personal and qualifying information with a third party 218-220.

In FIG. 8a, user 202 selects the set of personal and qualifying information they wish to procure as in step 404 of FIG. 4. ManageMyReport.com 204 displays the data available 802, along with the associated pricing 804, so the user can complete the transaction. In this example, Equifax data is selected at a price of $15.99.

In FIG. 8b, the user 202 has the option to supplement the personal and qualifying information with user generated content as in step 502 of FIG. 5. In the example shown, the user is prompted to provide their first name 806, middle name 808, last name 810, driver's license 812, driver's license state 814, home phone 816 and mobile phone 818 as in step 506 of FIG. 5. In some embodiments user generated content may comprise other information such as that required for an automotive credit application, a mortgage application, a rental application, or a job application.

In FIG. 8c, user 202 can view their personal and qualifying information for their own use 820, or they may select one or more items to share with a third party 822 as in step 606 of FIG. 6. In this example, the user sees the personal and qualifying information type (credit report) 824, the data repository it is from 826, a link to view the personal and qualifying information 820, a box to select said personal and qualifying information to share with third party 822, and a button to initiate the share instructions 828.

In FIG. 8d, user 202 is able to invite a third party to view the data that has been shared as in step 608 of FIG. 6. In this example the user is prompted to provide the email address of the third party 830, a subject line 832, and a personal note to the third party 834. The user has the option to ‘cancel’ 836, which will abort the initialization of any sharing or ‘send’ 838, which will continue as described in step 610 of FIG. 6. In some embodiments, the user may be asked to provide other types of contact information, such as email, telephone number, facsimile number, mailing address, etc.

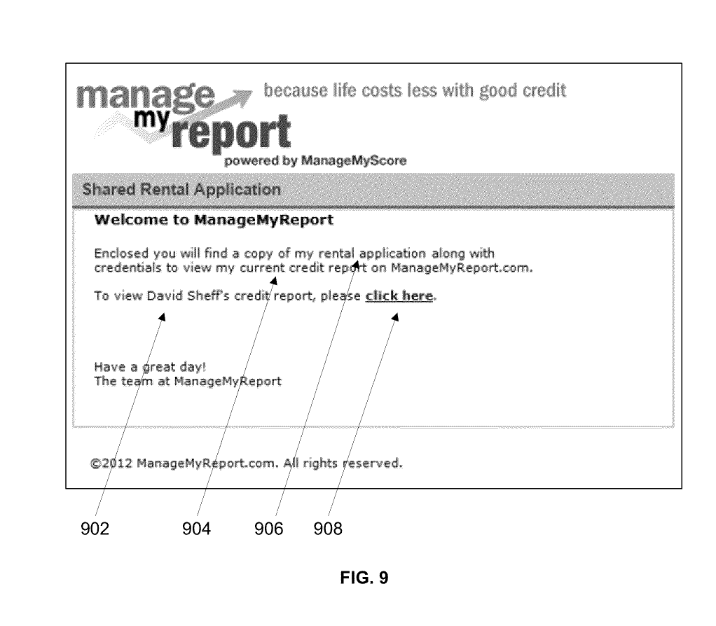

FIG. 9 is an illustration depicting an embodiment of the notification received by a third party 218-220 as in step 610 of FIG. 6.

As shown in this example, David Sheff 902 has shared a credit report 904 from a data repository 206-212 and a rental application 906 with the third party recipient 218. In addition, a link 908 to view the personal and qualifying information is provided.

Such an interface may be provided via email or other means such as a window that opens when the user logs into the ManageMyReport.com 204, SMS message, MMS message, facsimile, etc.

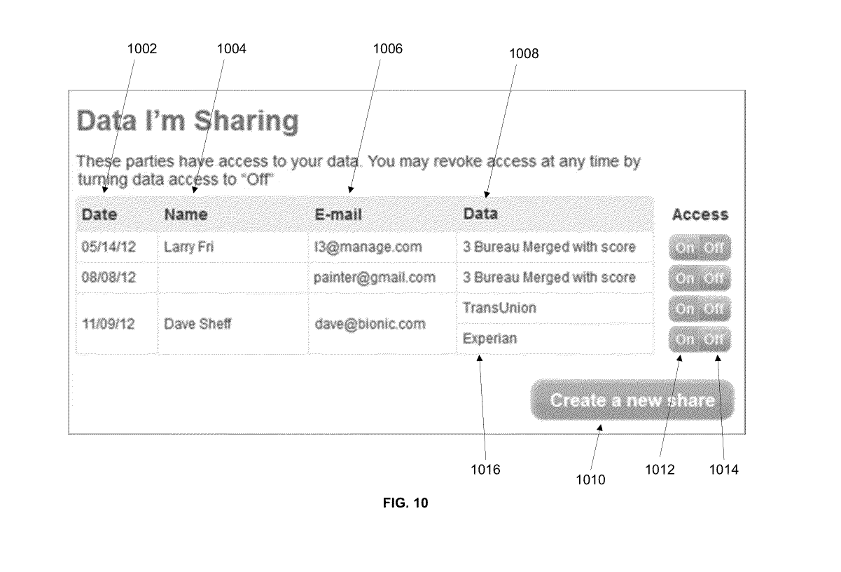

FIG. 10 is an illustration depicting an embodiment of the output displayed to a user who has shared data with a plurality of third parties. This example comprises a plurality of data fields including date 1002, name 1004, email address 1006, data 1008 and access status 1012-1014 for a plurality of third parties 218-220 that the user has shared with. Access to share said data with third party is controlled by selecting the intended value, on 1012 or off 1014.

In this example, if the user 202 wished to revoke access to the Experian data 1016, the user would select “off” in the Access column 1014 corresponding to the Experian 1016 data row. In some embodiments, other relevant data fields may be displayed to the user 202. In some embodiments, the data column 1008 will not be depicted as text, but will have other methods of defining them, including but not limited to imagery or icons.

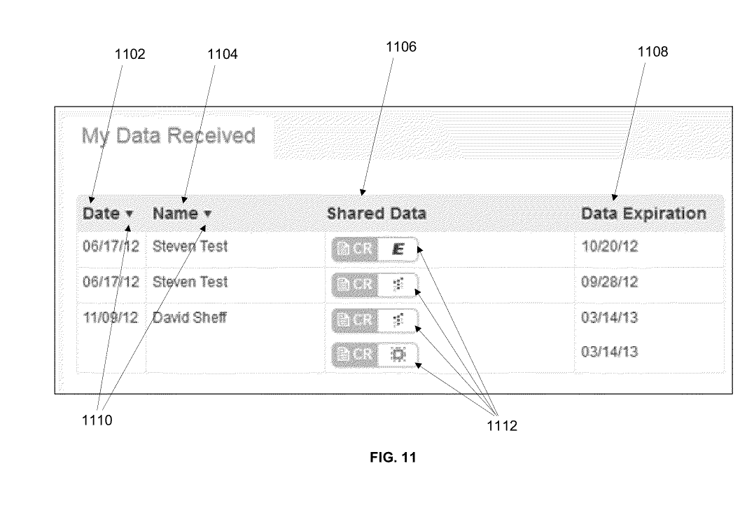

FIG. 11 is an illustration depicting an embodiment of the output displayed to third party 218-220 when personal and qualifying information has been shared with them. In this example, the output comprises a plurality of relevant data fields such as date 1102, name 1104, shared data 1106 and expiration date 1108 for a plurality of users 202. The data fields displayed can be sorted 1110 and contain linked icons 1112 to retrieve the shared personal and qualifying information.

As shown in this example, the users (Steven Test and David Sheff) 1104 have shared personal and qualifying information depicted as icons 1112. A date 1108 is shown to represent the date this data was shared, and a second date is shown to represent the date access to the data will expire. In some embodiments, there will be no data expiration date. In some embodiments, other relevant data fields will be displayed to the third party 218-220. In some embodiments, the shared data will not be depicted as icons, but will have other methods of defining them.

The invention can be implemented in numerous ways, including as a process; a system; a computer program product embodied on a computer readable storage medium; and/or a processor, such as a processor configured to execute instructions stored on and/or provided by a memory coupled to the processor. In this specification, these implementations, or any other form that the invention may take, may be referred to as techniques. In general, the order of the steps of disclosed processes may be altered within the scope of the invention. Unless stated otherwise, a component such as a processor or a memory described as being configured to perform a task may be implemented as a general component that is temporarily configured to perform the task at a given time or a specific component that is manufactured to perform the task. As used herein, the term ‘processor’ refers to one or more devices, circuits, and/or processing cores configured to process data, such as computer program instructions.

A detailed description of one or more embodiments of the invention is provided below along with accompanying figures that illustrate the principles of the invention. The invention is described in connection with such embodiments, but the invention is not limited to any embodiment. The scope of the invention is limited only by the claims and the invention encompasses numerous alternatives, modifications and equivalents. Numerous specific details are set forth in the following description in order to provide a thorough understanding of the invention. These details are provided for the purpose of example and the invention may be practiced according to the claims without some or all of these specific details. For the purpose of clarity, technical material that is known in the technical fields related to the invention has not been described in detail so that the invention is not unnecessarily obscured.

1. A method of permitting a user to securely share personal and qualifying data about the user with a third party through a website server, the personal and qualifying data being stored in at least one of a plurality of data repositories having personal and qualifying data about the user, comprising the steps of:
a) the website server accepting information from the user identifying a data repository holding personal and qualifying data about the user;
b) the website server accepting authentication information from the user;
c) the website server submitting the authentication information from the user to the data repository identified by the user in step (a), to authenticate the user to the data repository identified by the user in step (a);
d) the website server instructing the data repository identified by the user in step (a) to provide personal and qualifying data about the user;
e) the website server displaying the personal and qualifying data to the user;
f) the website server accepting information from the user identifying a third party to be given permission to view the personal and qualifying data;
g) the website server accepting authentication information from the third party verifying that the third party has the user's permission to view the personal and qualifying data; and
h) the website server displaying the personal and qualifying data to the third party.

2. (canceled)

3. (canceled)

4. The method of claim 1, wherein in step (e) the website server displays the personal and qualifying data by instructing the data repository identified by the user in step (a) to send the data directly to the user.

5. The method of claim 1, wherein in step (h) the website server displays the personal and qualifying data by instructing the data repository identified by the user in step (a) to send the data directly to the third party.

6. The method of claim 1, further comprising the step of the website server accepting and storing user generated content from the user to be displayed to the third party to supplement the personal and qualifying data from the data repository identified by the user in step (a) when the personal and qualifying data is displayed to the third party in step (h).

7. The method of claim 6, wherein step (e) further comprises displaying the user generated content along with the personal and qualifying data provided by the data repository.

8. (canceled)

7. (canceled)

8. (canceled)

9. A method of permitting a user to securely share personal and qualifying data about the user through a website server with a third party, the personal and qualifying data being stored in at least one of a plurality of data repositories having personal and qualifying data about the user, comprising the steps of:
a) the user providing information to the website server identifying a data repository holding personal and qualifying data about the user;
b) the user verifying the user's identity to the data repository identified by the user in step (a) by providing authentication information to the website server;
c) the user viewing the personal and qualifying data displayed by the website server from the data repository identified by the user in step (a); and
d) the user providing information to the website server, identifying a third party to be given permission to view the personal and qualifying data.

10. (canceled)

11. The method of claim 9, wherein in step (c) the personal and qualifying data viewed by the user is as displayed by the website server by instructing the data repository identified by the user in step (a) to send the data directly to the user.

12. The method of claim 9, further comprising the step of the user providing user generated content to the website server to store and display to the third party to supplement the personal and qualifying data from the data repository identified by the user in step (a).

13. The method of claim 12, wherein step (c) further comprises the user viewing the user generated content along with the personal and qualifying data provided by the data repository identified by the user in step (a).

14. The method of claim 9, further comprising the step of the user revoking permission of the third party to view the personal and qualifying data.

15. The method of claim 9, wherein the personal and qualifying data is selected from a group consisting of credit data, motor vehicle data, insurance data, criminal data, sex offender data, occupancy data and employment data.

16. A method of permitting a third party to securely view personal and qualifying data about a user through a website server, the personal and qualifying data being stored in at least one of a plurality of data repositories having personal and qualifying data about the user, comprising the steps of:
a) the third party receiving notification from the user via the website server that the third party has been granted permission by the user to access to personal and qualifying data about the user from a data repository holding personal and qualifying data about the user;
b) the third party verifying the third party's identity to the website server by providing authentication information to the website server; and
c) the third party viewing the personal and qualifying data about the user for which permission to access was granted by the user, sent by the website server.

17. (canceled)

18. The method of claim 16, wherein in step (c) the personal and qualifying data viewed by the third party is displayed by the website server by instructing the data repository identified by the user in step (a) to send the data directly to the third party.

19. The method of claim 16, wherein step (c) further comprises the third party viewing user generated content along with the personal and qualifying data provided by the data repository.

20. The method of claim 1, further comprising the step of the website server accepting information from the user revoking permission of the third party to view the personal and qualifying data.

21. The method of claim 1, in which step (h) further comprises the step of the website server checking status of the permission given to the third party to view the personal and qualifying data, and the personal and qualifying data is only displayed to the third party if the permission has not been revoked.

22. The method of claim 1, wherein the personal and qualifying data is selected from a group consisting of credit data, motor vehicle data, insurance data, criminal data, sex offender data, occupancy data and employment data.
